(19) United States
(12) Patent Application Publication
(10) Pub. No.: US 2014/0294149 A1
(43) Pub. Date: Oct. 2, 2014

(54) Image Support

(71) Applicants: Johannes Rieber, Olching (DE); Markus Roßmeier, Bamberg (DE)

(72) Inventors: Johannes Rieber, Olching (DE); Markus Roßmeier, Bamberg (DE)

(21) Appl. No.: 14/227,832

(22) Filed: Mar. 27, 2014

(30) Foreign Application Priority Data
Mar. 27, 2013 (DE) DE 102013205469.6

(51) Int. Cl. G06T 7/00; G06T 3/40; G01N 23/04; G06T 11/60

(52) U.S. Cl. CPC G06T 7/004; G06T 7/0012; G06T 11/60; G06T 3/40; G01N 23/04; G06T 2207/10124; G06T 2210/41; G06T 2207/20221; G06T 2207/30021
USPC 378/62; 382/132

(57) ABSTRACT

A method includes x-ray image recording of a sequence of overview images of a guidewire during movement of the guidewire through an occlusion, and continuously updated determining of the position of the guidewire using an image recognition algorithm from the overview images. The method also includes continuously updated determining of the position of a tip of the guidewire using a further image recognition algorithm from the overview images, and determining a sequence of zoom images from the sequence of overview images. The zoom images, based on the position determination of the tip of the guidewire, show a cutout with the tip that is enlarged from the overview x-ray images. The method also includes automatic real-time display of at least one overview image with a displayed guidewire in each instance together with at least one zoom image with a displayed tip of the guidewire on a display unit.

This application claims the benefit of DE 10 2013 205 469.6, filed on Mar. 27, 2013, which is hereby incorporated by reference in its entirety.

### BACKGROUND

The present embodiments relate to image support during a movement of a guidewire through an occlusion of a hollow organ of a patient.

In the instances of chronic total closure of a coronary vessel (e.g., a chronic total occlusion (CTO)), attempts are made within the scope of a heart catheter examination to open the total closure using different techniques and to reestablish the antegrade blood flow. Common to all techniques in such cases is that the point of the total occlusion is to be passed with a guidewire. Since, using angiography imaging, only one region of the vessel filled with contrast agent may be displayed, the course of the vessel at the point of the CTO may not be traced or may only be traced with difficulty. For this reason, previous recordings such as, for example, earlier computed tomography sectional images may be used in order to reconstruct the course of the closed vessel.

If, however, as is frequently the case, small channels also exist within the total occlusion, the guidewire is able to find its way through the CTO “itself” on account hereof. Channels of this type are not visible in a normal x-ray image (e.g., an angiography image). In such cases, an examiner may proceed such that the examiner moves the tip of the guidewire toward the CTO, until the wire bends slightly. The guidewire is then under pressure/stress and generates thrust toward the CTO. Since pressure only builds up in a very small periphery, the risk of perforation of the vessel is ruled out. The examiner then carefully rotates the wire tip until the guide wire travels in or through one of the small channels in the CTO. For this purpose, the examiner requires the best possible optical information (e.g., using a continuous monitoring of the movement of the guidewire using x-ray imaging).

### SUMMARY AND DESCRIPTION

When presenting the x-ray images in the prior art, there is the problem of an overview display of the guidewire showing too few details, and with a zoom display, there is the risk of the guidewire tip moving out of the zoomed region.

The scope of the present invention is defined solely by the appended claims and is not affected to any degree by the statements within this summary.

The present embodiments may obviate one or more of the drawbacks or limitations in the related art. For example, image support that allows for a good visualization of a movement of a guidewire through an occlusion in a hollow organ is provided.

In accordance with one or more of the present embodiments, a method for image support during a movement of a guidewire through an occlusion of a hollow organ of a patient includes X-ray image recording of a sequence of overview images of a guidewire during the movement of the guidewire through the occlusion. The method also includes continuously updated determining of the position of the guidewire using an image recognition algorithm from the overview images, continuously updated determining of the position of a tip of the guidewire using a further image recognition algorithm from the overview images, and determining of a sequence of zoom images from the sequence of overview images. The zoom images, based on the position determination of the tip of the guidewire, show a section with the tip that is enlarged from the overview x-ray images. The method also includes automatic real-time display of at least one overview image with a displayed guidewire in each instance together with at least one zoom image with a displayed tip of the guidewire on a display unit.

The method provides, for example, an optimal visualization of all relevant information for an examiner implementing a therapy of an occlusion of a hollow vessel of a patient. An overview image is displayed, on which the guidewire is shown and thus the position and orientation of the guidewire may be identified, and at the same time, an enlarged view of the guidewire tip in the region of the occlusion and thus the precise starting point for opening the occlusion is displayed. These views are updated in real-time, and the positions of the guidewire and the guidewire tip are determined from the respectively most up-to-date recording so that the examiner is able to implement the best possible therapy. Using the display, the examiner is able to accurately estimate the path that the guidewire tip will take and will promptly react accordingly. By displaying the zoom images based on the position determination of the guidewire tip, the tip may not be moved out of the zoom image on account of patient movements (e.g., heart or breathing movements), which in addition brings about a particularly reliable display and as a result renders a therapy even safer.

According to one embodiment, a zoom image is assigned in each instance to each overview image and is displayed simultaneously with the image. The most up-to-date overview image and an associated zoom image are therefore shown in each instance in real-time (which may include a minimal time offset on account of image processing), so that the examiner may always accurately and directly identify the position in which the guidewire and the tip are disposed. Optimal treatment of the patient is provided as a result.

For an easily identifiable arrangement of the images, a zoom image as a picture-in-picture is shown in each instance in an overview image. This is advantageous, for example, in the case of very large-surface display units (e.g., Large Display from Siemens AG). Alternatively, a zoom image and an overview image may also be displayed adjacent to one another in each instance. This is advantageous in the case of display units that include a number of display segments.

The zoom images may include an enlargement of at least a factor four compared with the overview images. In this way, the tip of the guidewire and the region directly adjacent thereto (e.g., a part of the occlusion) may be displayed particularly well and is easily identifiable by the examiner.

Tracking algorithms are used in order to determine the positions of the guidewire and/or tip of the guidewire.

In order to implement the method of one or more of the present embodiments, an x-ray device is provided. The x-ray device includes a recording system having an x-ray source and an x-ray detector for recording a sequence of overview images. The x-ray device also includes a control unit for actuating the method. The x-ray device includes an image system with an image processing unit for processing the overview images, for determining the positions and for determining the zoom images. The x-ray device also includes a display unit for the shared real-time display of overview images and zoom images.

### BRIEF DESCRIPTION OF THE DRAWINGS

FIG. 1 shows a display of an overview image according to the prior art;

FIG. 2 shows a display of a zoom image according to the prior art;

FIG. 3 shows a combined display of overview image and zoom image according to the present embodiments; and

FIG. 4 shows a sequence of one embodiment of a method for image support during a movement of a guidewire through an occlusion of a hollow organ.

### DETAILED DESCRIPTION

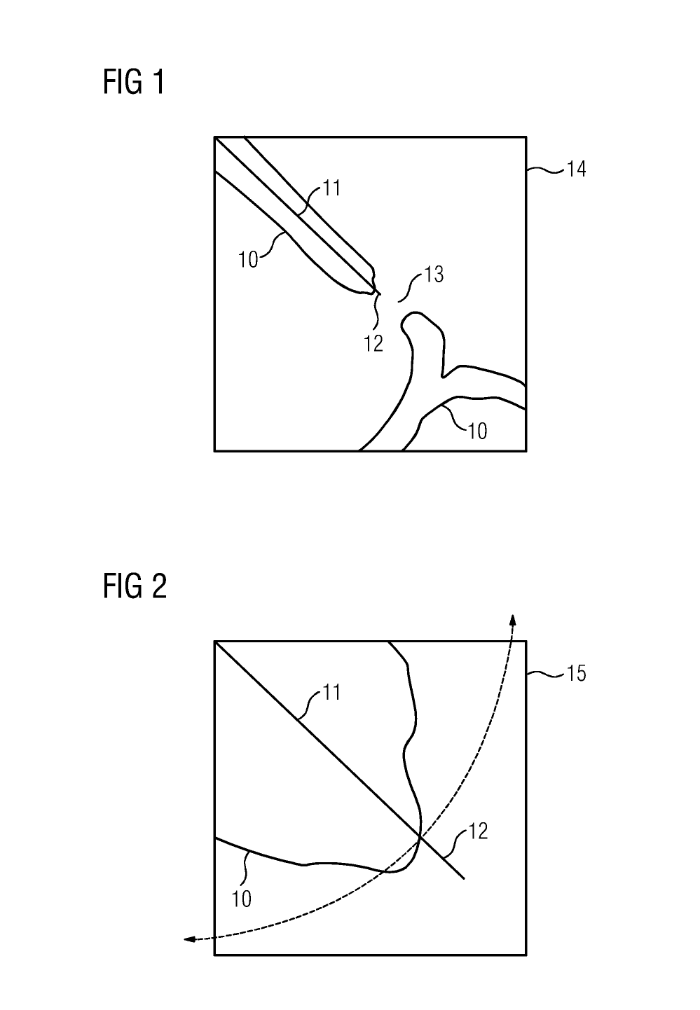

Known types of displays in the case of an image support of an interventional operation are shown in FIGS. 1 and 2. In an overview image 14 from a sequence of overview images, which may be continuously recorded in the x-ray image support, a hollow organ 10 of a patient and an occlusion 13 closing the hollow organ at one point are shown. A guidewire 11 inserted by an examiner with a guidewire tip 12 arranged at a distal end may be visible more or less satisfactorily on the overview image. As an alternative to the overview image, a zoom image 15 created by a local enlargement of the overview image may be displayed. The problem of zoom images includes the guidewire tip that may be identified in advance in the zoom image being moved out of the zoom image in the case of movements in the vascular system (e.g., breathing movements, heart movements), indicated by the dashed arrow.

On account of the method of one or more of the present embodiments for image support, all information that is relevant to an examiner, who implements a therapeutic opening of the occlusion in the hollow organ, may be clearly and explicitly visible at the same time and updated continuously. The method provides that an intervention of this type for the patient may be implemented in a safer and more gentle manner.

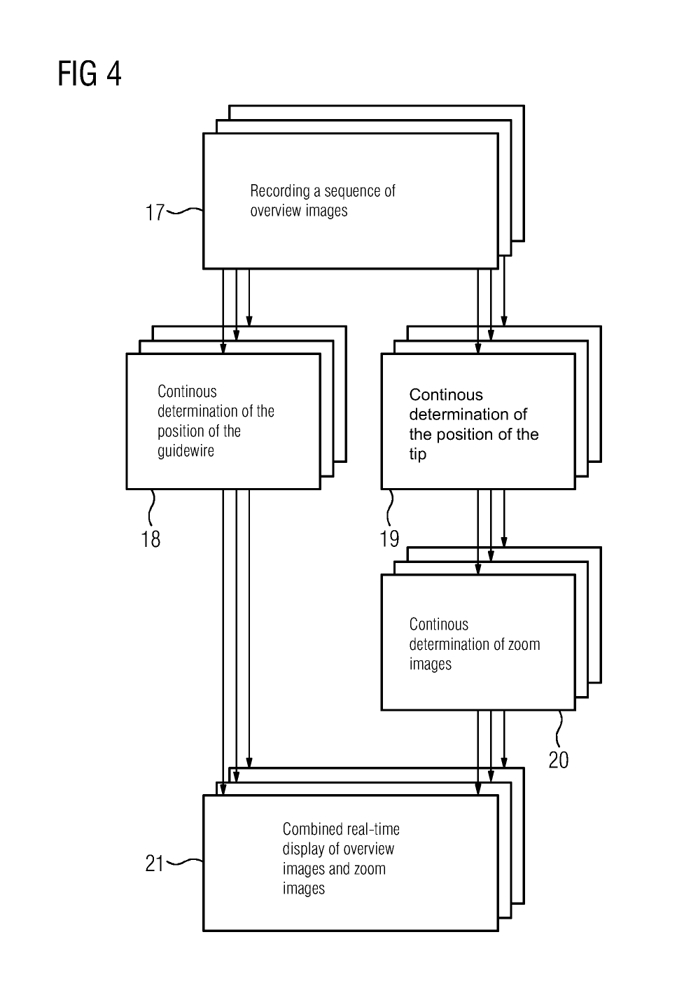

FIG. 4 shows acts of an automatic method of one or more of the present embodiments. This is implemented live and in real-time during an intervention, in which a guidewire 11 with a guidewire tip 12 is moved through a hollow organ (e.g., a coronary vessel) of a patient and, for example, during a therapeutic opening of an occlusion of the hollow cavity. In act 17 during a specific definable period of time (e.g., during an intervention), a continuous sequence of overview images (e.g., fluoroscopy) of the corresponding hollow organ of the patient is recorded with the guidewire. The sequence is indicated in FIG. 4 by, in each instance, three boxes, where, for example, more overview images (e.g., a plurality of overview images) are recorded. The overview images, which may be formed, for example, by angiography images, are, for example, recorded by an x-ray device with a three-dimensionally movable recording system (e.g., C-arm system).

As soon as an overview image is recorded in each instance, the position and orientation of the guidewire is determined with the aid hereof in act 18. This may be implemented automatically using a software algorithm that may be actuated using an image processing unit of an image system. Algorithms for tracing catheters or guidewires are known from the prior art (e.g., from patent application Ser. No. U.S. Ser. No. 13/778,454). At the same time, the position of the guidewire tip is determined using a further software algorithm in act 19 with the aid of the respective current overview image. This algorithm may also be actuated by the image processing unit of the image system. Algorithms of this type (e.g., tracking algorithms) are known from the prior art.

In act 20, a section from the overview image, which contains the guidewire tip, is enlarged to form a zoom image based on the position determination of the guidewire tip. In act 21, the overview image with a displayed guidewire and the zoom image with a displayed guidewire tip are shown together in real-time (e.g., with almost no or very little time delay with respect to the recording). For this reason, without any problem for the algorithms for determining guidewire position and position of the guidewire tip, very little time may be required. The respective current overview image and the associated zoom image may be indicated together. Alternatively, the zoom image from the previous overview image may be indicated together with the most up-to-date overview image, if, for example, a very rapid sequence of overview images is created.

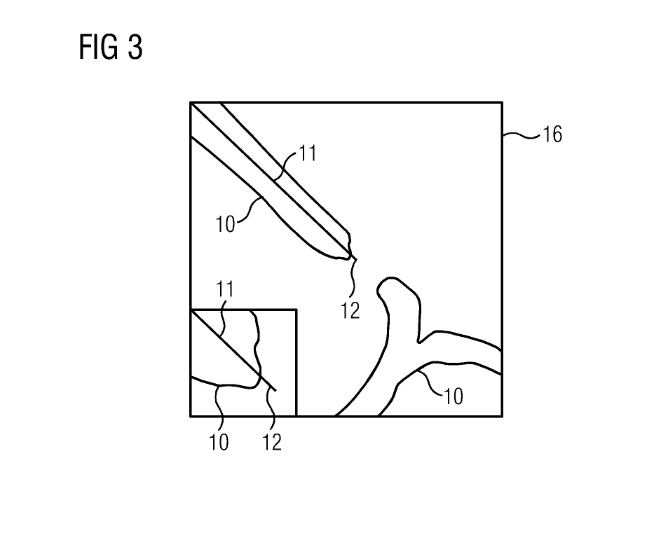

An overview image and a zoom image are shown together in each instance. The zoom image may be displayed as a “picture-in-picture” with the overview image, or both images may be displayed adjacent to one another (e.g., on a subdivided monitor). FIG. 3 shows such a combination image 16. The zoom image shows the guidewire tip and the immediate surroundings thereof. The enlargement factor of the zoom image compared with the overview image may be twice, four-times, eight-times or higher, for example. The enlargement is to be selected such that the behavior of the guidewire tip is optimally visible. On account of the continuously updated position determination of the guidewire tip and the enlargement based thereupon, the tip remains visible in the zoom image, and the tip may not be moved out of the zoom image on account of movements (e.g., of the heart or by breathing). In the overview image, in comparison therewith, the position and orientation of the entire guidewire may be identified in the hollow organ (e.g., vascular tree) so that the examiner obtains an optimal overview (e.g., if the guidewire is manipulated for an intervention in order to open an occlusion). All acts of the method are updated continuously (e.g., during a defined, previously set period of time or until the procedure is aborted manually).

For a particularly good monitoring of interventional operations in order to open occlusions in hollow organs, a method for image support during a movement of a guidewire through an occlusion of a hollow organ of a patient is provided. The method includes x-ray image recording of a sequence of overview images of a guidewire during the movement of the guidewire through the occlusion, continuously updated determining of the position of the guidewire using an image recognition algorithm from the overview images, and continuously updated determining of the position of a tip of the guidewire using a further image recognition algorithm from the overview images. The method also includes determining a sequence of zoom images from the sequence of overview images. The zoom images, based on the position determination of the tip of the guidewire, show the section with the tip that is enlarged from the overview x-ray images. The method also includes automatic real-time display of at least one overview image with a displayed guidewire in each instance together with at least one zoom image with a displayed tip of the guidewire on a display unit.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for image support during a movement of a guidewire through an occlusion of a hollow organ of a patient, the method comprising:
x-ray image recording a sequence of overview images of the guidewire during the movement of the guidewire through the occlusion;
continuously updated determining a position of the guidewire using an image recognition algorithm from the overview images;
continuously updated determining of a position of a tip of the guidewire using a further image recognition algorithm from the overview images;
determining a sequence of zoom images from the sequence of overview images, the zoom images, based on the position determination of the tip of the guidewire, showing a section with the tip of the guidewire that is enlarged from the overview x-ray images; and
automatic real-time displaying of at least one overview image with a displayed guidewire together with at least one zoom image with a displayed tip of the guidewire on a display unit.

2. The method of claim 1, wherein a zoom image is assigned to each overview image respectively and is displayed at the same time.

3. The method of claim 1, wherein a zoom image is displayed as a picture-in-picture in an overview image in each instance.

4. The method of claim 1, wherein a zoom image and an overview image are displayed adjacent to one another.

5. The method of claim 1, wherein the zoom images have an enlargement of at least a factor four compared with the overview images.

6. The method of claim 1, wherein tracking algorithms are used in order to determine the positions of the guidewire, the tip of the guidewire, or the guidewire and the tip of the guidewire.

7. The method of claim 2, wherein a zoom image is displayed as a picture-in-picture in an overview image in each instance.

8. The method of claim 2, wherein a zoom image and an overview image are displayed adjacent to one another.

9. The method of claim 3, wherein a zoom image and an overview image are displayed adjacent to one another.

10. The method of claim 2, wherein the zoom images have an enlargement of at least a factor four compared with the overview images.

11. The method of claim 3, wherein the zoom images have an enlargement of at least a factor four compared with the overview images.

12. The method of claim 4, wherein the zoom images have an enlargement of at least a factor four compared with the overview images.

13. The method of claim 2, wherein tracking algorithms are used in order to determine the positions of the guidewire, the tip of the guidewire, or the guidewire and the tip of the guidewire.

14. The method of claim 3, wherein tracking algorithms are used in order to determine the positions of the guidewire, the tip of the guidewire, or the guidewire and the tip of the guidewire.

15. The method of claim 4, wherein tracking algorithms are used in order to determine the positions of the guidewire, the tip of the guidewire, or the guidewire and the tip of the guidewire.

16. The method of claim 5, wherein tracking algorithms are used in order to determine the positions of the guidewire, the tip of the guidewire, or the guidewire and the tip of the guidewire.

17. An x-ray device configured for image support during a movement of a guidewire through an occlusion of a hollow organ of a patient, the x-ray device comprising:
a recording system having an x-ray source and an x-ray detector operable to record a sequence of overview images of the guidewire during the movement of the guidewire through the occlusion;
a control unit configured to actuate the image support;
an image system comprising an image processing unit, the image processing unit configured to:
process the overview images;
determine, in a continuously updated manner, a position of the guidewire using an image recognition algorithm from the overview images;
determine, in a continuously updated manner, a position of a tip of the guidewire using a further image recognition algorithm from the overview images; and
determine a sequence of zoom images from the sequence of overview images, the zoom images, based on the position determination of the tip of the guidewire, showing a section with the tip of the guidewire that is enlarged from the overview x-ray images; and
a display unit configured for the shared real-time display of the overview images and the zoom images.
